(19) United States
(12) Patent Application Publication
(10) Pub. No.: US 2020/0026890 A1
(43) Pub. Date: Jan. 23, 2020

(54) Smart Equipment Energizer and Method for Using

(71) Applicants: Brandon Iglesias, New Orleans, LA (US); Daniel Medina, Sylmar, CA (US)

(72) Inventors: Brandon Iglesias, New Orleans, LA (US); Daniel Medina, Sylmar, CA (US)

(21) Appl. No.: 16/512,793

(22) Filed: Jul. 16, 2019

Related U.S. Application Data
(60) Provisional application No. 62/700,125, filed on Jul. 18, 2018.

(51) Int. Cl. G06K 7/10; G06K 19/07; G06K 9/00

(52) U.S. Cl. CPC G06K 7/10366; G06K 9/00006; G06K 9/00221; G06K 19/0723

(57) ABSTRACT

The device restricts access to machinery by smart technology, camera machine vision, facial recognition, radio frequency identification or fingerprinting. The machine remains inoperable unless the operator's personal identification data is recognized by the device. The device can also provide tutorial to new hires.

### CROSS REFERENCE TO RELATED APPLICATIONS

Applicants claim priority to Provisional Application No. 62700125, which was filed Jul. 18, 2018.

### STATEMENT REGARDING FEDERAL SPONSORED RESEARCH

None.

### PARTIES TO JOINT RESEARCH AGREEMENT

None.

### FIELD OF THE INVENTION

A device provides a user controlled access to power equipment and power tools (collectively, “machines”). The purpose of the device is to lock down machines except for authorized training and use by designated personnel. The input components of the device are: Quick Response [“QR”] reader or tablet/smartphone or QR Code/Bar Code, machine/computer vision [“facial recognition”] or Radio-Frequency Identification [“RFID”] or Near Field Communication [“NFC”] or fingerprint scan [collectively “smart technology”]. The storage, processing and execution component of the device is in the device's controller. The controller stores, processes and executes commands through a non-transitory computer-readable medium at the computing system. And, the output component for the device is a WIFI antennae or hard wired ethernet cable, which signals at least one machine. The device can recognize the trainee or user, permit access to the machine, provide step-by-step instructions for use of the machine, determine level of alertness of user, determine when two or more users are required for safety requirements, and determine whether user is wearing appropriate safety gear, such as helmet, goggles, apron, gloves and/or steel-toed shoes. The device can also determine whether the user's hair is appropriately fashioned, meaning, short, in a bun, with a tight hair net, and not hanging down loose. A method for using the device is also provided.

### BACKGROUND OF THE INVENTION

Controlling access to power equipment and power tools is necessary in the work-place to insure safe operation, to prevent unauthorized use by unqualified personnel or non-mission related users, and to properly train new hires on sophisticated machinery. Given the substantial investment in machinery, the employer or owner is motivated to restrict access. It is standard in the industry to lock-out and tag-out machinery (meaning mechanically turn the machine off so that it cannot be re-started and put a tag on the machine indicating inoperability), when the machine is not in use or down for repairs or maintenance. The purpose of the Smart Equipment Energizer Device (“device” for short) is to introduce smart technology to more efficiently and safely operate machinery.

Others have developed applications for allowing access to a home or through portals using smart technology, see for instance, Matsuoka U.S. Pat. No. 10,332,059 (smart-sensor security system), and Siminoff U.S. Pat. No. 10,334,701 (electronic device for controlling lights). None have taken the next significant step of controlling access to operation of machinery and providing tutorial with smart technology.

Currently, owners control access to machinery by using chains or wires with locks. The drawback to the current method of such mechanical access is that each user must locate a supervisor to obtain a key on each occasion before use. A further drawback of the current method is that new hires must be trained by a person on site. Even where the new hire had prior classroom instructions on the particular piece of equipment or tool, he or she will certainly benefit from having instruction on the actual equipment or tool associated with his or her job duties, or receiving enforcement of a “buddy system” with verification of wearing proper personal protective equipment real-time from machine vision or computer vision.

Some power equipment and power tools have intrinsic safety features to turn the machine off, such as interlocks, shields or guards, and two-handed controls, to reduce the number of accidents. These types of machines will shut down in the event of unsafe operation, for instance, by using one hand on the controls where the purpose is to keep both hands away from nip-points. However, the current state of the art does not allow the owner to designate users and discriminately restrict access by untrained personnel, and does not provide for remote tutorial on the proper use of the equipment and tools.

### SUMMARY OF THE INVENTION

An owner with power equipment and power tools seeks to restrict access to the machinery. The owner places the device which is box-shaped, near a machine, or in proximity to several machines. The device contains a controller on a control board, which stores, processes and executes commands through a non-transitory computer-readable medium at the computing system inside a box. Personal data regarding a user or trainee seeking access to the machine is transmitted to the device's controller through a QR reader or tablet/smartphone, or QR Code/Bar Code, or finger print scanner via a light-emitting diode [“LED”], or by a camera system for facial recognition, or by RFID tag and reader or NFC reader [collectively “smart technology”], where a receiver for the smart technology can be positioned on top or on a side of the box. Data is inputted through the receiver to the device's controller at the computing system. The computing system stores data related to all authorized users and trainees, and compares the stored data to inputted personal data by a prospective user or trainee obtained through the LED, camera system or RFID reader or NFC reader. The controller processes the data, and then transmits an electrical impulse via an antennae or power cord or hard wired ethernet to the on-off switch on the machine as well as another signal to a light bulb to confirm or deny access to the machine. The denial of access means that the machine is in lock-out, and the light bulb flashes red to indicate lock-out. The machine also has a monitor or screen for tutorial which can be initiated by the device's controller through the non-transitory computer-readable medium at the computing system. The device can supply power to the monitor or the screen for tutorial through a power cord connection.

In one embodiment, at least one trainee or at least one user with a table/smartphone approaches the LED on the device's box and inputs his code or scans the machine's code with his/her phone application (“app”), as a means of entering his personal information. Alternatively, at least one trainee or at least one user approaches the LED on the box or serial/USB port or connector with adapters for RFID card, smartphone, NFC, or biometric reader, to have his or her fingerprints scanned or identified as a means of entering his or her personal information. In some circumstances, more than one trainee or more than one user may approach the LED on the box. The device's controller which is inside the box, processes the personal information, compares it to stored data, and if the trainee or user is recognized, then issues a command first, to cause a light bulb to flash green, and second, to cause a signal to transmit through a WIFI antennae or hard-wired ethernet or through an interlock on the machine to turn on the machine; or if the prospective user is not recognized, then the device's controller issues a command to cause a light bulb to flash red and may also send email or text notification, and the machine remains turned off. When appropriate, the device's controller issues a command through the antennae to commence a tutorial which is displayed on a monitor located on or near the machine.

### BRIEF DESCRIPTION OF THE DRAWINGS

FIG. 1 is a block diagram illustrating the components of the Smart Equipment Energizer device.

FIG. 2 is a prospective view of the device.

FIG. 3 is an backside view of the device.

FIG. 4 is an exploded view of the components inside the device.

FIG. 5 is a schematic top view of the electronic wiring for the control board.

FIG. 6 is a schematic bottom view of the electronic wiring for the control board.

FIG. 7 is a schematic top view of the electronic wiring for the power board.

FIG. 8 is a schematic bottom view of the electronic wiring for the power board.

FIG. 9 contains a screen shot of the operating instructions on a monitor for a machine owner's computer system.

FIG. 10A and FIG. 10B contain screen shots after initiation of the device on the monitor for the machine owner's computer system.

FIG. 11 is a screen shot on the monitor for the machine owner's computer system showing the status of the machine and power source or energizer information.

FIG. 12 is a screen shot on the monitor for the machine owner's computer system showing scheduling for use.

FIG. 13 is a screen shot on the monitor for the machine owner's computer system showing a computer operator's options in editing power source.

FIG. 14 is a screen shot on the monitor for the machine owner's computer system showing a computer operator's options to control access and provide tutorial.

### DETAILED DESCRIPTION OF SEVERAL EXAMPLE EMBODIMENTS

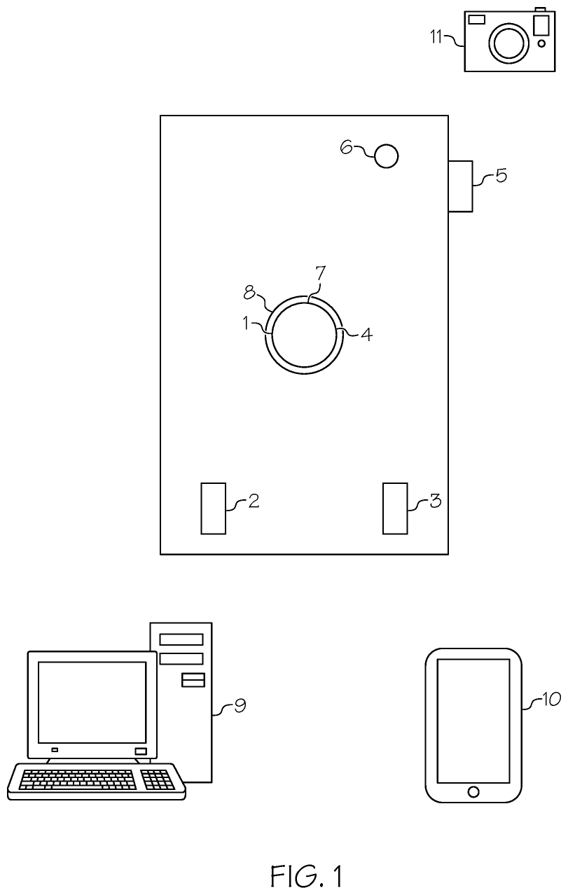

A machine is turned off, and cannot be turned on except through the Smart Equipment Energizer device. In this embodiment, the device comprises a box with a LED FIG. 1, No. 1, on a side, which a LED or a connector with adapter is at least one means for inputting personal information from a prospective user's fingerprints into the device's controller through a non-transitory computer-readable medium at the computing system inside the box. The box has at least one power source FIG. 1, No. 2, and No. 3, in order to operate the computing system, and a WIFI antennae for transmitting signals from the computing system to a machine. Another means for inputting personal information into the device's controller is by video and/or by still camera, FIG. 1, No. 6. Another means for inputting personal data is by RFID tag and RFID reader, FIG. 1, No. 11. And, another means for inputting personal information into the device's controller includes by an external computer or laptop, collectively FIG. 1, No. 9., or by a smart phone or tablet, or another method is via NFC for smartphone, tablet or card, collectively, FIG. 1, No. 10. The device's computing system compares the inputted personal information of the prospective user to previously inputted and stored data for all authorized users. The previously inputted and stored data for all authorized users originates with the machine's owner. Where the personal information of the prospective user is not recognized when compared to the previously inputted and stored data, then the device's controller causes an electronic error signal to be transmitted through a light bulb on a side of the box FIG. 1, No. 8 to flash red, and the machine remains turned off. And where the personal information of the prospective user is recognized, then the device's controller causes an electronic signal to be transmitted through the light bulb on the side of the box, FIG. 1, No. 8 to flash green, and sends another electronic signal through the WIFI antennae or hard-wired ethernet or power cable, which directs the machine to be turned on. The device's controller can also cause an electronic error signal to be transmitted through the light bulb on a side of the box to flash blue for standby, when there is a pause or interruption in operation of the machine.

The LED, camera, RFID reader, NFC reader, QR code reader or bar code reader are connected to on-line servers, FIG. 1, No. 7, so that personal information can be transmitted remotely. A manager can override the Smart Equipment Energizer device, when necessary, by means of a pass key, FIG. 1, No. 5. The device's controller then causes an electronic error signal to be transmitted through the light bulb on the side of the box to flash white for override. When the user has completed his work on the machine, he or she turns off the machine by pressing a job done button on the side of the box, FIG. 1, No. 4. The machine is then locked down or locked out, and inoperable. The manager can also set the hardware to automatically turn off when the camera detects no user or the current meter notices that the machine has been idle for a period of time set for use.

In the event that the prospective user is a trainee, he or she approaches the device with the LED FIG. 1, No. 1, on the side, where the LED is at least one means for inputting personal information from the trainee into the device's controller through the non-transitory computer-readable medium at the computing system inside the box. The box has at least one power source FIG. 1, No. 2, and No. 3, in order to operate the device's computing system, and a WIFI antennae. Another means for inputting personal information into the device's controller is by video and/or by still camera, FIG. 1, No. 6. Another means for inputting personal data is by RFID tag and RFID reader, by NFC and NFC smartphone or NFC card reader, collectively at FIG. 1, No. 11. And, another means for inputting personal information into the device's controller is by an external computer or laptop, collectively FIG. 1, No. 9., or by a smart phone or tablet, collectively, FIG. 1, No. 10. The inputted personal information is compared to stored data for all authorized trainees. Where the personal information of the trainee is not recognized, then the device's controller causes an electronic error signal to be transmitted through the light bulb on the side of the box FIG. 1, No. 8 to flash red, and the machine remains turned off. And where the personal information of the trainee is recognized, then the device's controller causes an electronic signal to be transmitted through the light bulb to flash green, and another electronic signal to be transmitted through the WIFI antennae or powered through one of the two power cords or powered to a contactor kit with relay, which directs the machine to be turned on and to display tutorial instruction for safe operation of the machine on a monitor adjacent to the machine. The tutorial can be power point display, or video.

Using the same components, more than one user can simultaneously approach the device. If more than one user is required for safe operation of the machine, then in one embodiment, each user must input personal information through the LED, FIG. 1, No. 1. Where the personal information of each prospective user is not recognized, then the device's controller causes an electronic error signal to be transmitted through the light bulb on the side of the box FIG. 1, No. 8 to flash red, and the machine remains turned off. And where the personal information of at least two prospective users is recognized, then the device's controller causes an electronic signal to be transmitted through the light bulb to flash green and another electronic signal to be transmitted through the WIFI antennae or powered through one of the two power cords or powered to a contactor kit with relay, to direct the machine to be turned on. A manager can override the device, when necessary, by means of a pass key, FIG. 1, No. 5. When the users have completed their work on the machine, then they turn off the machine by pressing the job done button on the side of the box, FIG. 1, No. 4.

The device can be configured in at least six operating modes: Mode one is an in-line, plug-and-play configuration for 110/120 volt, 20 ampere, 50/60 Hertz machine, where the machine (for example a drill press benchtop) is plugged into the device and the device is plugged into wall outlet.

Mode two is an in-line, hard-wired configuration for 110/120 volt, 20 ampere, 50/60 Hertz machine, where the machine is hard wired to the terminals on the device and the device is plugged into wall outlet.

Mode three is a smart-power-relay configuration where the device acts as a relay to a contactor kit, where the contactor kit is configured for higher voltage, phase and amperage use in cases for machine specific needs. In this mode the device does not contact the higher powered machine, but simply acts as a relay.

Mode four is a smart-control-milliamp relay configuration for 4 to 20 milliamp control boards, where the device is connected to a rectifier for 4 to 20 milliamp control board interfacing. An example of this type of use mode is for interfacing with machine specific boards.

Mode five is a smart-control-voltage-relay configuration for low voltage direct current control board interfaces. An example of this type of use mode is for interfacing with level controls, that run on voltage signals −48 to 48 volt, 0-5 volt, 0-12 volt, etc.

Mode six is a smart-pneumatic-relay configuration where the device is interfaced with a pneumatic system.

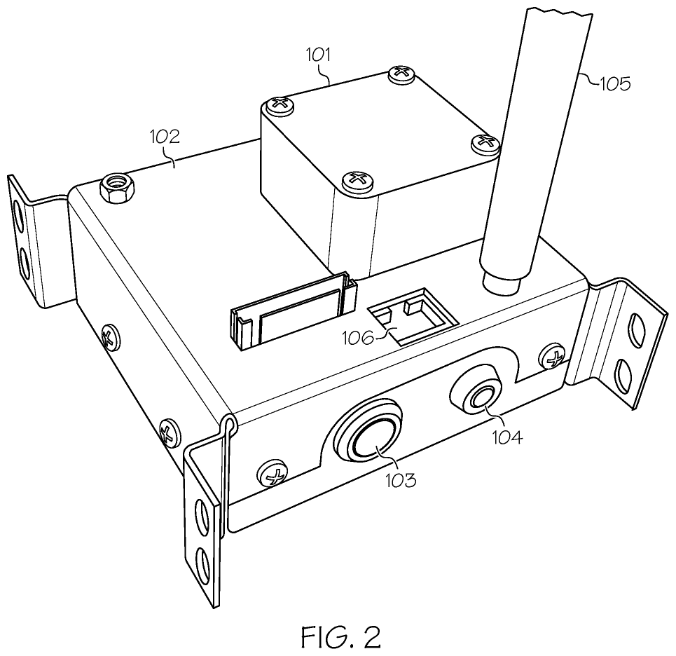

A prospective view of the device is at FIG. 2, No. 101. A platform is at No. 102. The LED is at No. 106. The override key receptacle is at No. 104. The job stop button is at No. 103. And the WIFI antennae is at No. 105. The control board contains a controller which transmits a signal through the power board and then to the antennae to transmit a signal to the machine to turn on, and to run the tutorial, when appropriate. The tutorial can be in the form of video, live-feed, or power point, displayed on a monitor near the machine.

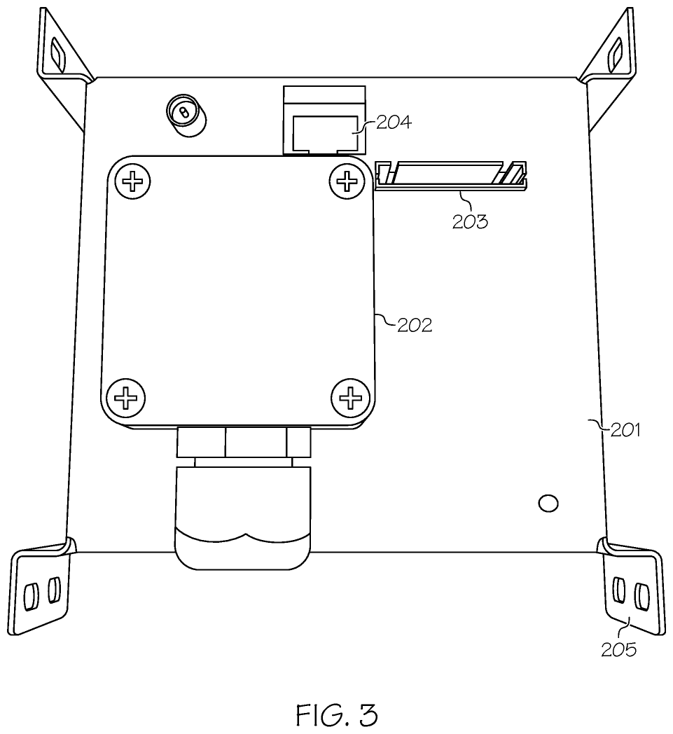

A prospective view from underneath the device is portrayed at FIG. 3, No. 201. The peripheral connector for a card reader, biometric input, vision input, and data port is at No. 203. An ethernet port is at No. 204. The power terminal enclosure for wall power or plug connection, which is rotatable is at No. 202. Mounting brackets are at No. 205.

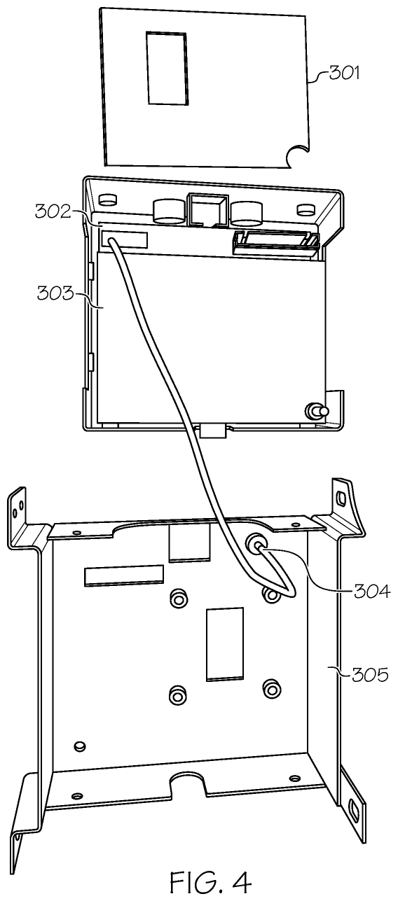

An exploded internal view of the device is at FIG. 4. The top has been removed, and the electrical insulation which is just under the top is at No. 301. The control board which contains the device's controller and computing system, is at No. 302. The power board is at No. 303. The antennae connection is at No. 304. And, the underside of the device is at No. 305.

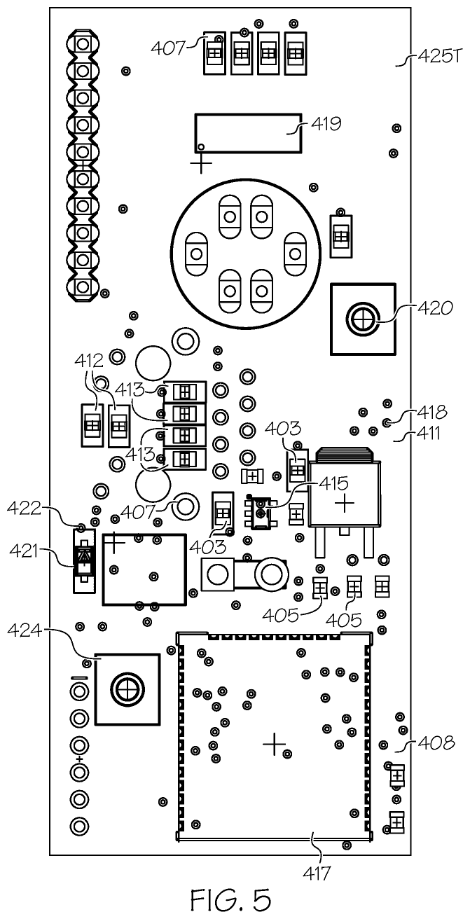

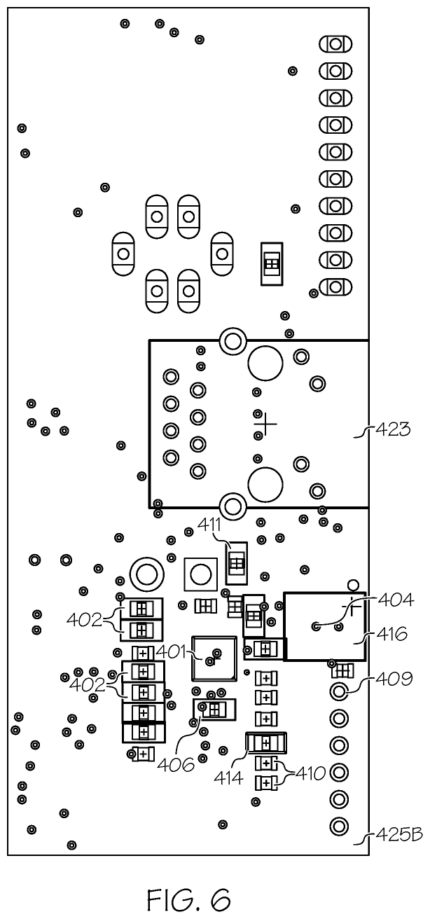

Schematic drawings of the control board are displayed in FIG. 5 and FIG. 6. The controller is comprised of the parts on the control board. The parts and their purposes for the control board, top at FIG. 5, No. 425T, and bottom at FIG. 6, No. 425B, [numbers are placed on top or on bottom drawing only, for convenience of location] are: LAN8720A 10/100 Ethernet PHY, handles ethernet connections, FIG. 6, No. 401; RDS SMD 1.5K OHM 5% 0.4W 0805, are resistors for the ethernet chip, FIG. 6, No. 402; CAP CER 0.1UF 50V Z5U 0805, are bypass capacitors, FIG. 5, No. 403; RES SMD 10 OHM 5% 0.4W 0805, is the terminating resistor for the oscillator, FIG. 6, No. 404; CAP CER 10UF 10V X5R 0805, are bypass capacitors, FIG. 5, No. 405; Thin Film Resistors −SMD 0805 12.1 Kohm 0.1% 25 ppm, is a reference resistor for the ethernet chip, FIG. 6, No. 406; RES SMD 1k OHM 0.5% 1/10W 0805, is a current limiting resistor for the transistor array, FIG. 5, No. 407; CAP CER 1UF 25V X7R 0805, are bypass capacitors, FIG. 5, No. 408; CAP CER 2.2 UF 10V X7R 0805, are bypass capacitors, FIG. 6, No. 409; CAP CER 22UF 6.3V X5R 0805, are bypass capacitors, FIG. 6, No. 410; RES SMD 4.7K OHM 1% 1/8W 0805, are pull up resistors, FIG. 5, No. 411; RES SMD 470 OHM 5% 1/8W 0805, is current limiting resistor for LED on RJ45, FIG. 5, No. 412; RES SMD 49.9 OHM 0.5% 1/10W 0805, are resistors for RJ45, FIG. 5, No. 413; Ferrite Bead 600 OHM 0805 1LN, is for noise reducing inductance on the power line for the ethernet chip, FIG. 6, No. 414; IC Detector Volt 3.0V ODRN 5SSOP, enables the 3V signal chip for the oscillator, FIG. 5, No. 415; ASV Series Oscillator, is the oscillator for ethernet chip, FIG. 6, No. 416; ESP32 Module, is the micro-controller unit [“MCU”] with WIFI ethernet, FIG. 5, No. 417; 3.3V, 1A Regulator, is the power supply for the MCU and ethernet chip, FIG. 5, No. 418; Transistor Array, controls switch for RGB LED on job stop button, FIG. 5, No. 419; SMT 6 mm switch, EVQQ2 series, resets and programs the MCU, FIG. 5, No. 420; Diode SCHOTTKY 40V 1A SOD 123A, provides protection against spike voltage from relay coil, FIG. 5, No. 421; 2×3 Female Header SMD, connects to power board, FIG. 5, No. 422; RJ45 Connector, is the ethernet cable input, FIG. 6, No. 423; and, Conn Header R/A 10POS 2.5 4mm, is the peripheral connector to be used to connect card readers and all future peripherals which may be connected to the device, FIG. 5, No. 424.

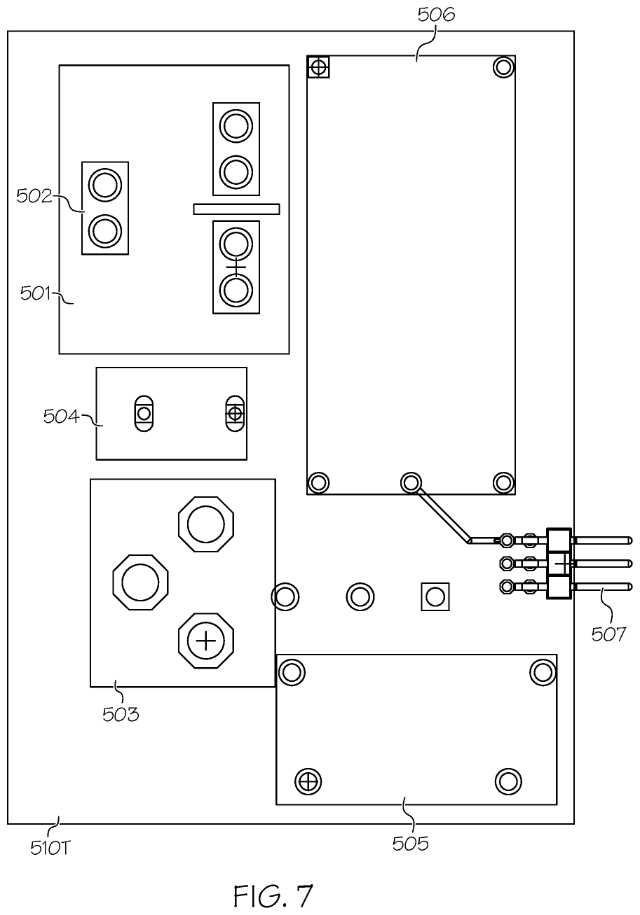

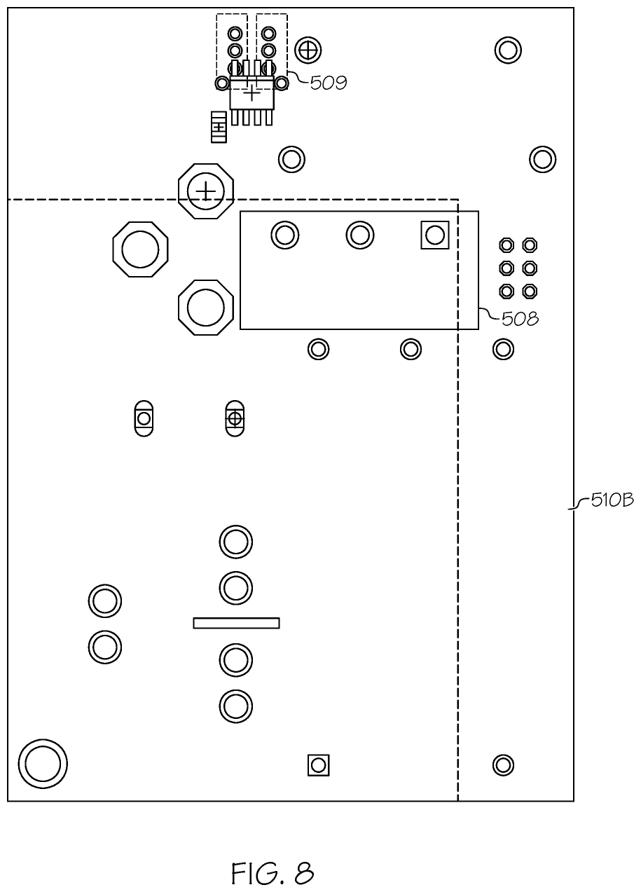

Schematic drawings of the power board are displayed in FIG. 7 and FIG. 8. The parts and their purposes for the power board, top FIG. 7, No. 510T, and bottom FIG. 8, No. 510B, [numbers are placed on top or on bottom drawing only, for convenience of location] are: IEC 320-C20, provides power input to device, FIG. 7, No. 501; IEC PCB Blade, connects power input to power board, FIG. 7, No. 502; PWR ENT RCPT NEMAS-20 Panel IDC, provides power output to a machine, FIG. 7, No. 503; Fuse Holder, protects against overcurrent, FIG. 7, No. 504; Relay Heavy Load 5VDC 20A, switches power to the machine, FIG. 7, No. 505; 5V Power Supply, converts power to the machine, FIG. 7, No. 506; 6 pin Connector, connects to the control board, FIG. 7, No. 507; Screw Terminal, provides power output to the machine, FIG. 8, No. 508; and, Current Sensor, measures current to the machine, FIG. 8, No. 509.

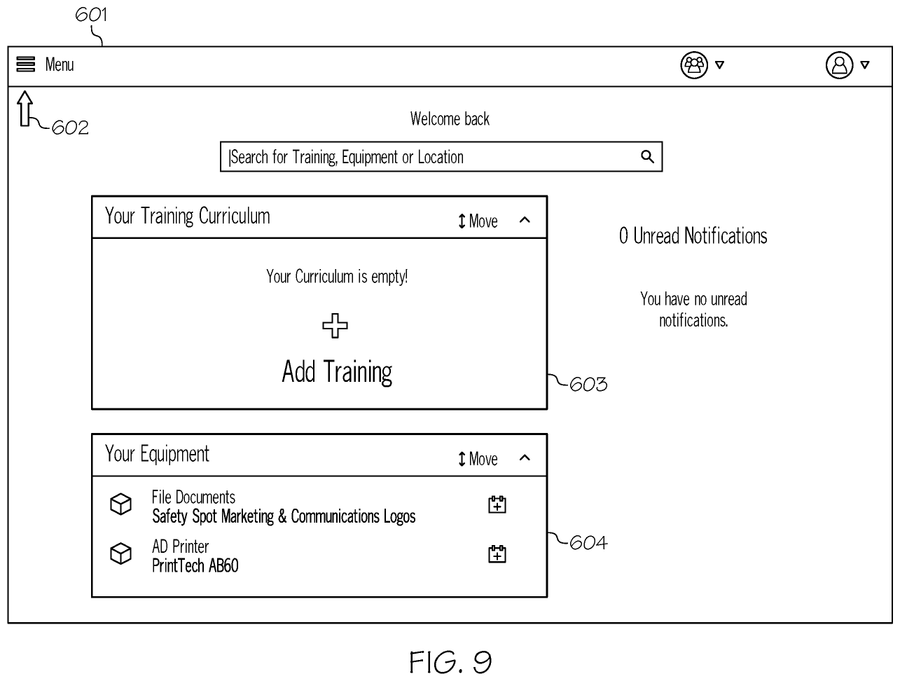

A machine owner's non-transitory computer-readable medium for its computer system acts as the master, and the device's computer system is the servant system. A screen shot on a monitor for the machine owner's computer system to initiate operating instructions to control the device's computing system is at FIG. 9, No. 601. The menu of instructions for guiding an operator of the machine owner's computer system is at No. 602, the training curriculum is at No. 603. And, the machine to be selected for operation is at No. 604. All of the personal information for authorized users and trainees is entered into and then stored in the device's computing system.

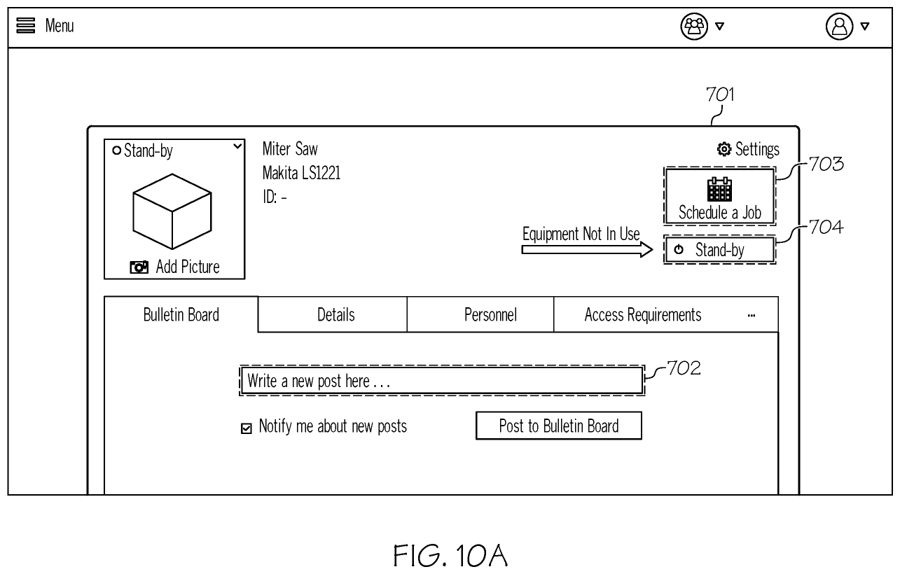

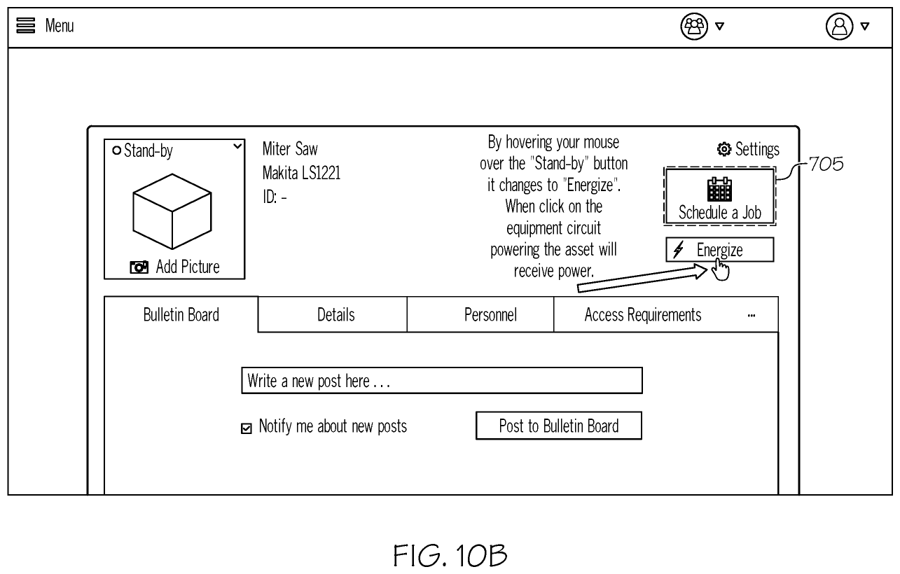

A first displayed screen shot on the monitor for the machine owner's computer system after the device's computing system has been initiated is at FIG. 10A, No. 701. In this example a Makita LS1221, power saw, is selected for use. The operator for the machine owner's computer system enters information typically through a keyboard or a mouse which is then reflect on the monitor, No. 702. The computer system provides options for scheduling a job at No. 703 and for stand-by at No. 704.

A second displayed screen shot on the monitor for the machine owner's computer system shows the operation of the selected power saw, at FIG. 10B. By hovering the mouse over the stand-by button, the equipment (the saw) is energized. When the mouse is clicked on the equipment circuit, the saw will receive power, No. 705.

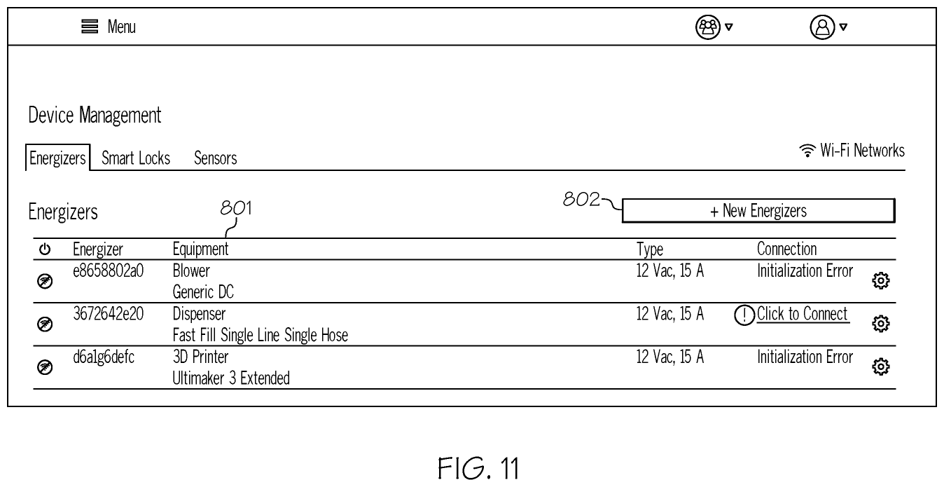

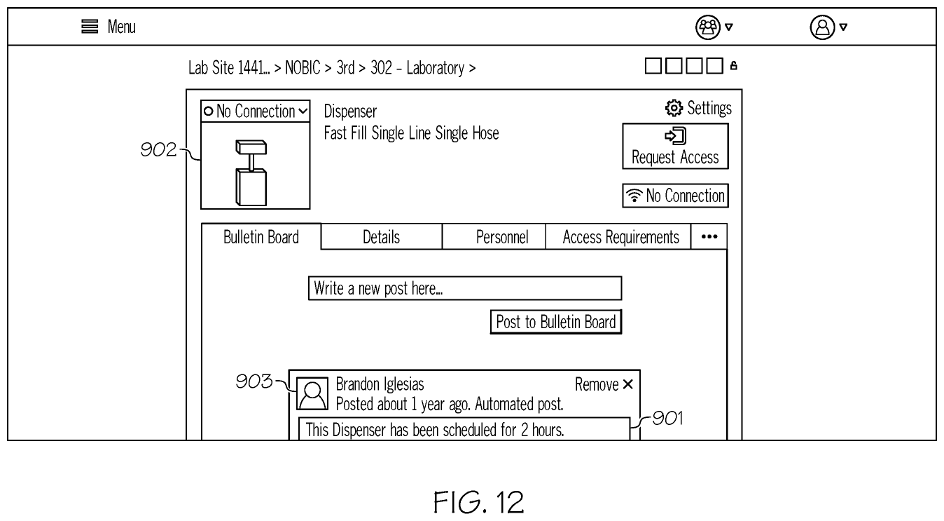

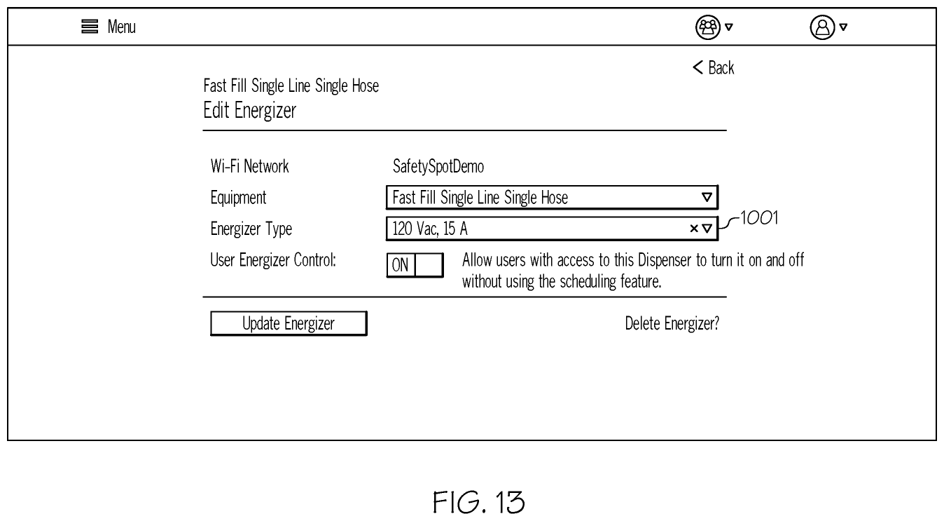

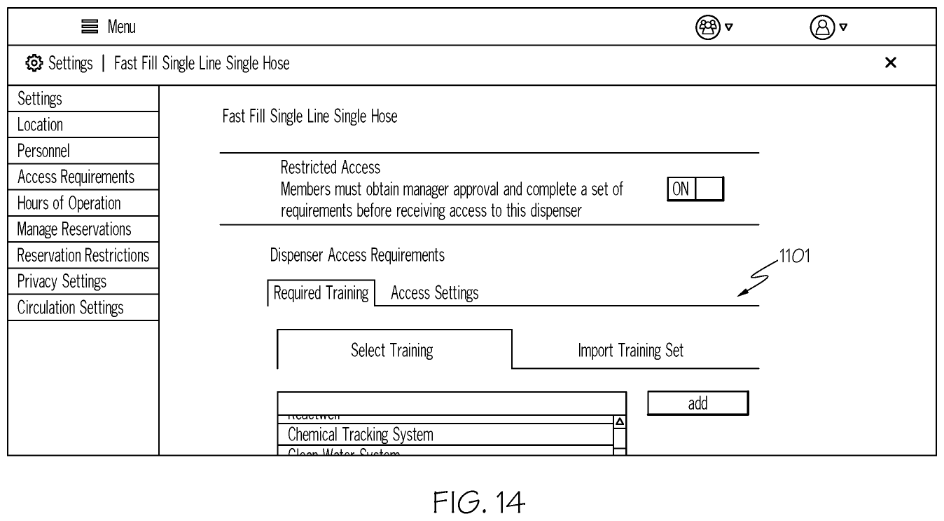

The machine owner's computer system controls the functions of the device, and screen shots available on the monitor for the machine owner's computer system provide information on the functions as the device is being used. The information displayed on the screen shots allows the operator of the machine owner's computer system to determine the status of the machine, or status of more than one machine—meaning whether the machine or machines are in operation, on stand-by, or on lock-down, FIG. 11, No. 801, and the power source and energizer for the machine, No. 802. With information on status of the machine or status of more than one machine, then the operator of the machine owner's computer system can schedule the machine for usage, FIG. 12, No. 901. The monitor screen identifies the specific machine in use, No. 902, and the machine's user, No. 903. The owner can lock down the machine, precluding access after hours. The device can be programmed to deny energizing outside of shop hours when requested by personnel who are non-management and administrative. The operator can change the energizer status, FIG. 13, No. 1001. And, the operator can set access requirements, to make sure that the user or trainee or new hire has been cleared for use or presented with tutorial prior to use, FIG. 14, No. 1101.

The method for using the device comprises a prospective user approaching the LED on the box, where in one embodiment, the LED, serial port, or fingerprint adapter works as a finger print scanner which is used to input personal information. In another embodiment, other smart technology including facial recognition, QR reader, NFC reader, RFID reader, or external computer, remote smart phone/tablet, is used to input personal information. The personal information of the prospective user is processed by the device's controller through the non-transitory computer-readable medium at the computing system and then compared to stored data for authorized users. Where the user's personal information is not recognized based on comparison with stored data for authorized users, then the controller transmits an electronic error signal through a light bulb on a side of the box which flashes red indicating that the prospective user is not authorized to use the machine and the machine remains turned off. The light bulb flashing red indicates that the machine is in lock out. In another embodiment, a text or email may accompany an unsuccessful attempt to access the machine. And where the personal data of the prospective user is contained in the stored information for all authorized users of the machine, then the device's controller first, causes an electronic signal to be transmitted through a light bulb on a side of the box which flashes green, and second, causes an electronic signal to be transmitted through the control board and then the power board sends power to the machine, while a WIFI antennae or hard-wired ethernet directs the machine to be turned on. The electronic signal may also initiate the tutorial.

While the invention has been depicted and described in detail above with respect to several exemplary embodiments, those of ordinary skill in the art will also appreciate that minor changes to the description, and various other modifications, omissions and additions may also be made without departing from either the spirit or scope thereof.

We claim:

1. A device which permits smart access for users of a machine, comprising:
a power machine which is turned off and cannot be turned on except by an authorized user;
a box which has a LED on a top side, where the LED works as a finger print scanner to input personal data;
where each prospective user of the machine must approach the LED so that the LED then scans personal data of the prospective user and transmits the personal data to a controller through a non-transitory computer-readable medium at a computing system inside the box;
where the non-transitory computer-readable medium at a computing system compares the personal data of the prospective user to stored information for all authorized users of the machine;
where the personal data of the prospective user is not contained in the stored information for all authorized users of the machine, then the controller causes an electronic error signal to be transmitted through a light bulb on a side of the box which flashes red indicating that the prospective user is not authorized to use the machine and the machine remains turned off;
and where the personal data of the prospective user is contained in the stored information for all authorized users of the machine, then the controller first causes an electronic signal to be transmitted through the light bulb on the side of the box which flashes green, and second causes an electronic signal to be transmitted through a WIFI antennae which directs the machine to be turned on.

2. The device of claim 1., where the LED accepts personal data by means of smart technology.

3. The device of claim 1., where personal data is inputted to the device by camera system for facial recognition.

4. The device of claim 1., where personal data is inputted to the device by RFID tag and RFID reader.

5. A device which permits smart access for trainees on a machine, comprising:
the power machine which is turned off and cannot be turned on except by an authorized, prospective trainee;
the box which has the LED on the top side, where the LED works as a finger print scanner to input personal data;
where each prospective trainee on the machine must approach the LED so that the LED then scans personal data of the prospective trainee and then transmits the personal data to a controller though the non-transitory computer-readable medium at a computing system inside the box;
where the non-transitory computer-readable medium at the computing system compares the personal data of the prospective trainee to stored information for all authorized trainees on the machine;
where the personal data of the prospective trainee is not contained in the stored information for all authorized trainees on the machine, then the controller causes an electronic error signal to be transmitted through the light bulb on the side of the box which flashes red indicating that the prospective trainee is not authorized to use the machine and the machine remains turned off;
where the personal data of the prospective trainee is contained in the stored information for all authorized trainees of the machine, then the controller first, causes an electronic signal to be transmitted through the light bulb on the side of the box which flashes green, and second, causes an electronic signal to be transmitted through the WIFI antennae which directs the machine to be turned on;
and where after the machine is turned on, then the controller causes an electronic signal to be transmitted through the WIFI antennae which directs a monitor located near the machine to display a video tutorial for the trainee.

6. The device of claim 5., where the LED accepts personal data by means of smart technology.

7. The device of claim 5., where personal data is inputted to the device by camera system for facial recognition.

8. The device of claim 5., where personal data is inputted to the device by RFID tag and RFID reader.

9. A device which permits smart, simultaneous access for multiple users of a machine, comprising:
a power machine that requires more than one user at a time, which is turned off and cannot be turned on except by at least two authorized users;
the box which has the LED on the top side, where the LED works as a finger print scanner to input personal data;
where each prospective user of the machine must approach the LED so that the LED then scans personal data of the prospective user and transmits the personal data to the controller through the non-transitory computer-readable medium at the computing system inside the box;
where the non-transitory computer-readable medium at the computing system compares the personal data of each prospective user to stored information for all authorized users of the machine;
where the personal data of each prospective user is not contained in the stored information for all authorized users of the machine, then the controller causes an electronic error signal to be transmitted through the light bulb on the side of the box which flashes red indicating that the prospective users are not authorized to use the machine and the machine remains turned off;
and where the personal data of each prospective user is contained in the stored information for all authorized users of the machine, then the controller first, causes an electronic signal to be transmitted through a light bulb on a side of the box which flashes green, and second, causes an electronic signal to be transmitted through a WIFI antennae which directs the machine to be turned on.

10. The device of claim 9., where the LED accepts personal data by means of smart technology.

11. The device of claim 9., where personal data is inputted to the device by camera system for facial recognition.

12. The device of claim 9., where personal data is inputted to the device by RFID tag and RFID reader.

13. A method comprising:
the prospective user approaches the LED on the box, and the LED works as a finger print scanner;
the personal information is transmitted to a controller for processing via the non-transitory computer-readable medium at the computing system in the box and compares the personal information to stored data for authorized users;
where the user's personal information is not recognized based on comparison with stored data for authorized users, then the controller causes an electronic error signal to be transmitted through the light bulb on the side of the box which flashes red indicating that the prospective user is not authorized to use the machine and the machine remains turned off;
and where the personal data of the prospective user is contained in the stored information for all authorized users of the machine, then the controller first, causes an electronic signal to be transmitted through the light bulb on the side of the box which flashes green, and second, causes an electronic signal to be transmitted through a WIFI antennae which directs the machine to be turned on.

14. The method of claim 13., where the LED accepts personal data by means of smart technology.

15. The method of claim 13., where personal data is inputted to the device by camera system for facial recognition.

16. The method of claim 13., where personal data is inputted to the device by RFID tag and RFID reader.
